(19) United States
(12) Patent Application Publication
(10) Pub. No.: US 2014/0157136 A1
(43) Pub. Date: Jun. 5, 2014

(54) Systems and Methods for Providing a Virtual Device for Controlling Streaming of Music

(71) Applicant: Senzari, Inc., Miami, FL (US)

(72) Inventors: Demian M. Bellumio, Miami, FL (US); Sue Sealock, Miami Beach, FL (US)

(73) Assignee: Senzari, Inc., Miami, FL (US)

(21) Appl. No.: 14/091,997

(22) Filed: Nov. 27, 2013

Related U.S. Application Data
(60) Provisional application No. 61/732,123, filed on Nov. 30, 2012.
(60) Provisional application No. 61/732,183, filed on Nov. 30, 2012.

(51) Int. Cl. H04L 29/06

(52) U.S. Cl. CPC H04L 65/60
USPC 715/738

(57) ABSTRACT

Embodiments of the present disclosure facilitate the streaming of media from an authorized media content provider to an end user navigating the website of an online provider without necessitating that the online provider obtain licenses to distribute the media. The streamed content is not downloadable (e.g. to the user's computer system or the provider's computer system), thereby protecting against unauthorized copying and redistribution of the media.

### CROSS-REFERENCE TO RELATED APPLICATIONS

This application claims priority to U.S. Provisional Patent Application Ser. No. 61/732,123, filed Nov. 30, 2012 and entitled “SYSTEMS AND METHODS FOR PROVIDING A VIRTUAL DEVICE FOR CONTROLLING STREAMING OF MUSIC,” and to U.S. Provisional Patent Application Ser. No. 61/732,183, filed Nov. 30, 2012 and entitled “SELF SERVICE PORTAL AND METHODS FOR USING SAME,” the disclosures of which are hereby incorporated herein by reference.

### TECHNICAL FIELD

Embodiments of the present disclosure relate to a virtual device for controlling the streaming of music or other media (such as audio and video) to an end user via a communications network. More particularly, embodiments of the present disclosure allow a licensed provider to stream non-downloadable media to an end user viewing a publisher's web site without necessitating the publisher to license the media.

### BACKGROUND

The internet has advanced so that it is commonplace for users to navigate the websites of online providers of goods and services for purchase of such goods and services. Many such online providers wish to provide streaming media (such as background music) for the enjoyment of visitors navigating the online provider's website. Among other things, the streaming of music can make navigating the provider's website more enjoyable and/or less stressful as compared to doing this when there is no music/background music.

Many online providers may also wish to provide musical options to the visitors of their websites so that the visitors can select the music they would like to hear. However, providing legal web-based streaming media (such as music) is a complicated matter due to the licenses required to publicly broadcast the music. In many cases, however, an online provider of a web page who wishes to stream media to viewers of the web page must invest considerable time and expense to secure all the necessary licenses to do so, and ensure that these licenses properly cover all the territories to which the media is streamed.

Embodiments of the present disclosure address these and other issues.

### SUMMARY

Embodiments of the present disclosure facilitate the streaming of media from an authorized media content provider to an end user navigating the website of an online provider without necessitating that the online provider obtain licenses to distribute the media. The streamed content is not downloadable (e.g. to the user's computer system or the provider's computer system), thereby protecting against unauthorized copying and redistribution of the media.

A computer-implemented method according to one embodiment includes: accessing, by a user computer system using, a web page hosted by a publisher computer system; receiving, by the user computer system, input from a user of the user computer system requesting streaming media via the web page; establishing, by the user computer system, a connection with a server providing the streaming media; and providing, by the user computer system, the streaming media from the server to the user via the web page.

The present disclosure includes methods and apparatuses which perform these methods, including data processing systems which perform these methods, and computer readable media containing instructions that, when executed by computing systems, cause the computing systems to perform these methods.

Other features will be apparent from the accompanying drawings and from the detailed description which follows.

### BRIEF DESCRIPTION OF THE DRAWINGS

A more complete understanding of certain embodiments may be derived by referring to the detailed description and claims when considered in connection with the following illustrative figures.

FIGS. 1A and 1B illustrate a flow diagram of an exemplary process according to various aspects of the present disclosure.

FIG. 2A is a block diagram of an exemplary system according to various aspects of the present disclosure.

FIG. 2B is an illustrative view of communication and flow between specific functionalities (e.g., radio bar, radio controller and server side API's) of an exemplary system according to various aspects of the present disclosure

FIG. 3 is an exemplary flow diagram illustrating a process directed to configuration checks.

FIG. 4 is an illustrative view depicting a screen shot with a rendered radio bar.

FIG. 5 is an illustrative view depicting a screen shot illustrating the major components of a radio bar.

FIGS. 6A and 6B are illustrative views depicting an exemplary radio bar in an active state, as well as collapsed and expanded views.

FIG. 7 is an illustrative view depicting a menu screen with a radio bar and illustrating the main menu for searching and station selection.

FIG. 8 is another illustrative view depicting a menu screen but illustrating the major components of the bar in a minimized state.

FIGS. 9A, 9B, and 9C are illustrative views depicting a screenshot of the radio controller window for default, logged in and active states.

FIG. 10 is a flow diagram illustrating a process for resetting the radio bar by closing the pop-under window.

FIG. 11 is a flow diagram illustrating a process for deactivating music streaming by closing the publisher's site/browser window.

FIG. 12 is an illustrative view depicting a screen shot of an exemplary browser's alert dialog to end or continue the session.

FIG. 13 is a flow diagram illustrating the login/sign up process for an end user according to various aspects of the present disclosure.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Any combination and/or subset of the elements of the methods depicted herein may be practiced in any suitable order and in conjunction with any suitable system, device, and/or process. The methods described and depicted herein can be implemented in any suitable manner, such as through software operating on one or more computer systems. The software may comprise computer-readable instructions stored in a tangible computer-readable medium (such as the memory of a computer system) and can be executed by one or more processors to perform the methods of various embodiments.

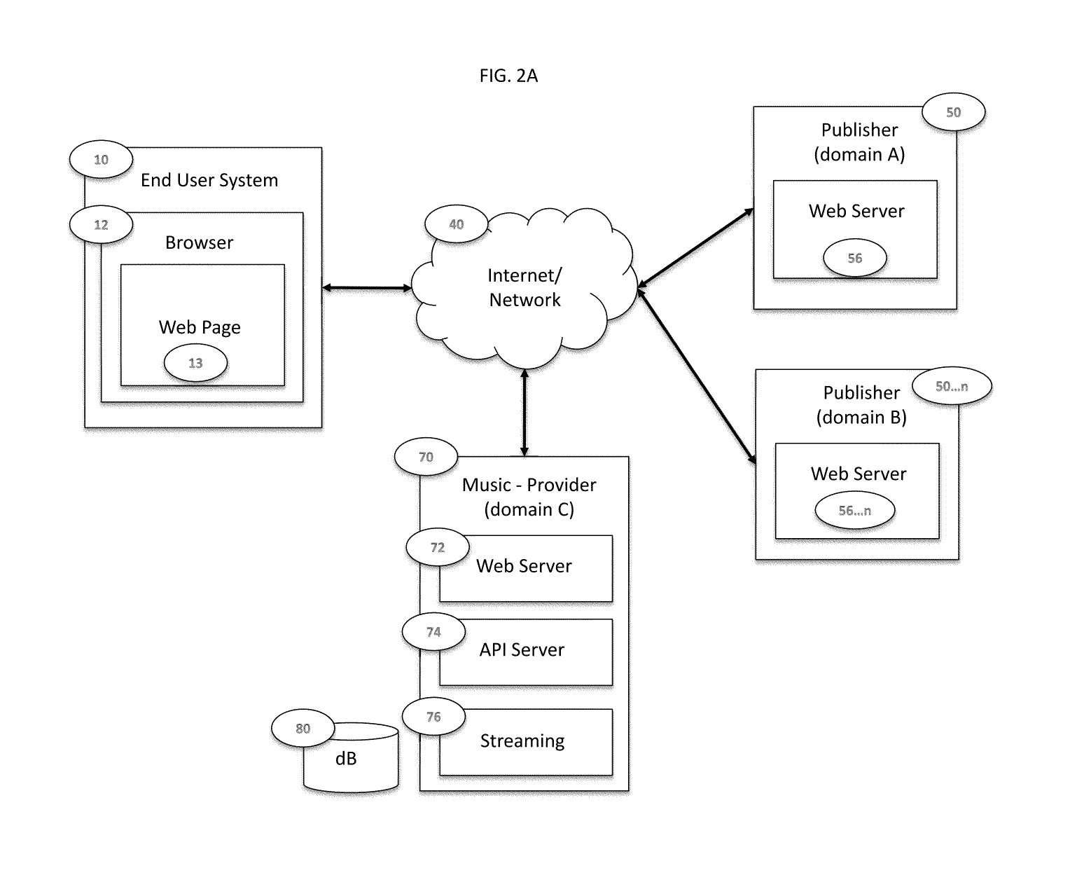

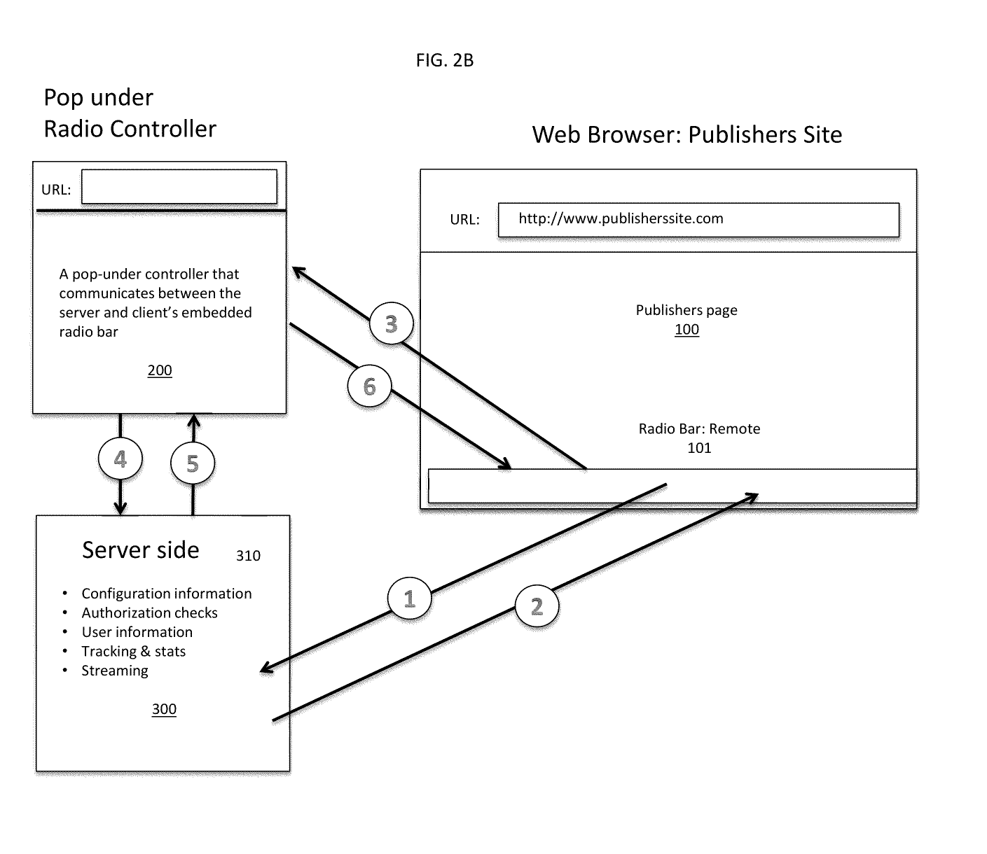

FIG. 2A is a block diagram of an exemplary system according to various aspects of the present disclosure. This exemplary system includes an end user system 10, network 40 (such as the Internet), one ore more publisher systems 50 each hosting one or more websites, and a music provider system 70 in communication with a database 80. The end user system 10, publisher 50 and the music provider system 70, may each be, or include, a computer system (including a processor, memory, user interface, and other components) to perform the functionality of the methods described herein.

The end user system 10 may include a web browser 12 to display and navigate a web page 13 hosted by the web server 56 of publisher 50. In the exemplary system depicted in FIG. 2A, the music provider system 70 includes a web server 72, an API server 74, and one or more applications 76 for streaming media to the end user. The music provider system 70 is configured such that a communications link is established through the communications network 40 between the end user system 10 and the music provider system 70 so that media (such as audio and/or video) can be streamed from the music provider system to the end user system. While the music provider 70 is shown as including each of the web server 72, the API server 74, and the streaming application(s) 76, each of these components may be implemented by any number of different systems.

As also shown in FIG. 2A, there can be one or more (e.g., N) publishers or websites connected to the network 40 and any one of which the end user system 10 can be communicatively coupled or connected to. Any number of different end users may be coupled or connected to any one of the publishers 50 at any given time. Thus, while exemplary embodiments may refer to an end user or a single end user, it shall be understood that it is within the scope of the present disclosure for the methods and systems described herein to be capable of streaming music to one or more end users who are communicatively coupled/connected to a given end user system

FIG. 2B provides an illustrative view of communication and flow between specific functionalities (e.g., radio bar, radio controller and server side API's) of an exemplary system according to embodiments of the present disclosure. In this example, a radio bar 101 embedded in the publisher's web page 100 acts as the remote; passing events, actions and requests to the radio controller 200, which serves the streaming media, handles user authentication, and acts as the proxy between the radio bar 101 and server side API's (API server 74, FIG. 2A) during streaming media sessions. The API interfaces 310 associated with the server 300 to allow the controller to request URLS for streaming, retrieve meta information, obtain the user's status and information, and write usage and manages tracking activities. In addition, the radio bar 101 also interacts with the back-end for player settings requirements.

Embodiments of the present disclosure may include one or more processes for initially configuring and controlling access to, and the playback of, streaming media. In particular, such methods may include establishing criteria for identifying what websites or publishers are authorized to gain access to a music streaming feature and, more particularly, to the type of music that is authorized to be played back to an end user who has accessed a given website.

Software/applications program being executed in connection with the publisher's web site 100 may be configured with the appropriate code elements (e.g., java script) required to allow the web site to cause some the functions associated with the method shown and described herein to be carried out.

In some exemplary embodiments, the publisher embeds Java Script (JS) code on their site/page/template to cause various functionality to be performed. For example, the JS code may be placed on all pages where the radio bar 101 should appear to implement the functionality of the radio bar. In addition to a radio bar, embodiments of the present disclosure may download code to implement any other type of user interface control.

In one exemplary embodiment, JavaScript code may write a friendly IFRAME and set up communications with the IFRAME. The IFRAME is used to proxy communication between the radio bar and controller along with asynchronously loading the JavaScript code in the HTML file. By loading the code asynchronously, the impact of loading the code on the web page is minimized. Using an IFRAME also ensures that if the back-end services are slow or offline, the web page served from the community provider's website continues to load and function like normal. Moreover, using an IFRAME also helps to avoid name collisions between the JavaScript code and the code on the web page.

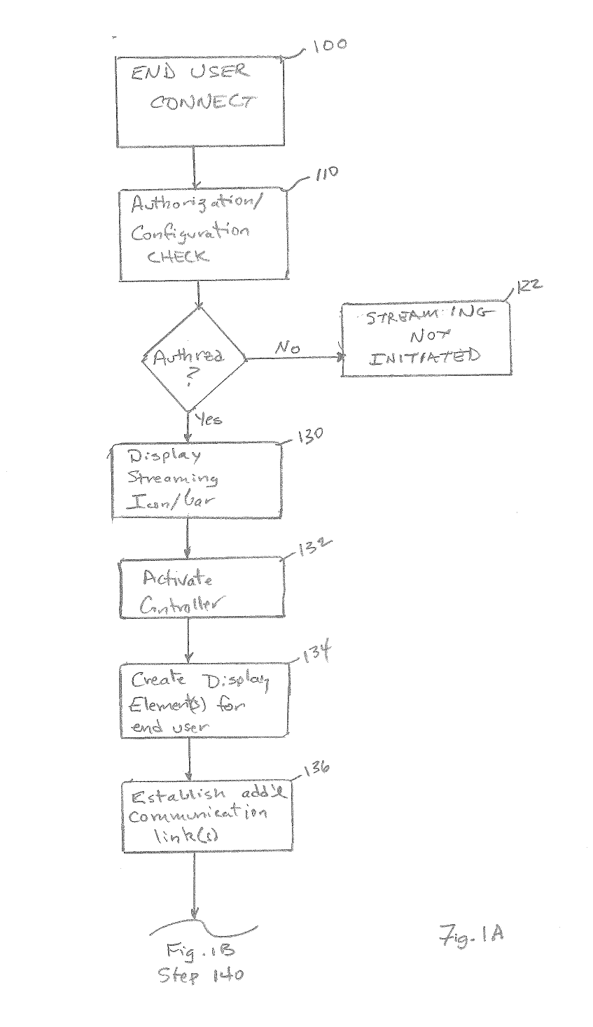

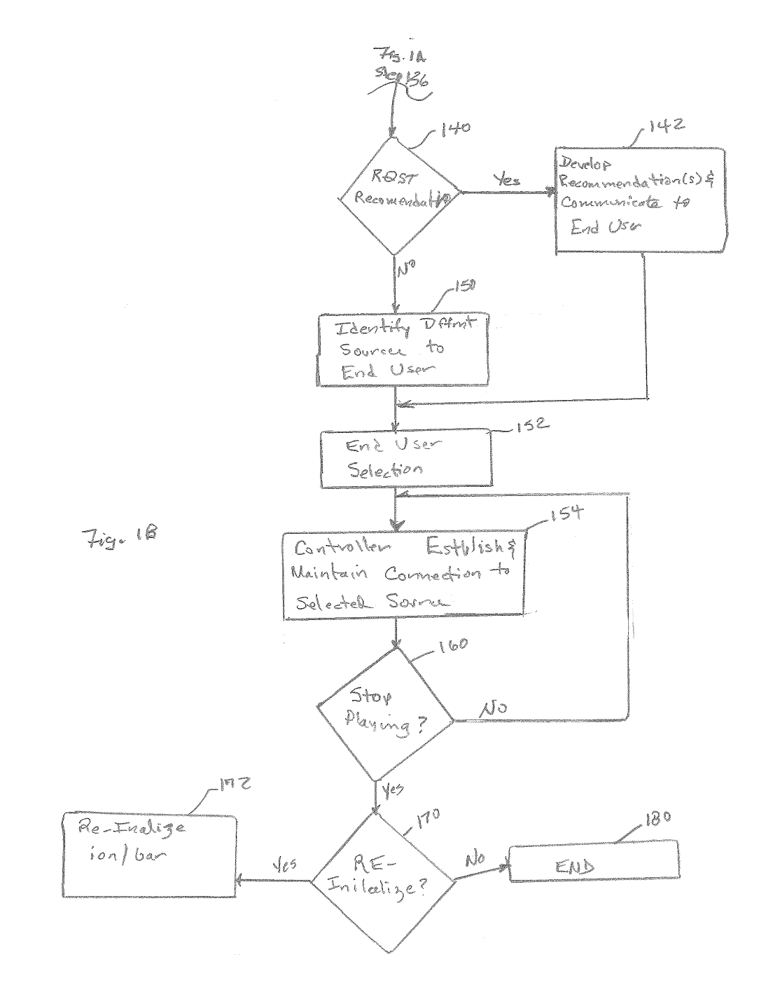

An exemplary process according to various aspects of the present disclosure is depicted in FIGS. 1A and 1B. In this example, an end user connects his/her digital device (e.g., computer, terminal, portable digital device or the like) to the website/publisher (Step 100). A check is made as to configuration and authorization (Step 110) and a determination is made whether such a check provides that music streaming is authorized (Step 120). If it is determined that music streaming is not authorized (Step 120, NO), then the process associated with music streaming or music play back initiated (Step 122) and the steps following step 120 are not to be carried out. It should be recognized that this does not mean that the connection between the end user and the website is broken nor that the end user cannot thereafter browse the website. Rather, for example, there may simply be no playback of music and the icon, button or other feature (i.e., the radio bar) associated with step 130 may not be displayed.

Such a check and determination process (Steps 110, 120) can embody any of a number considerations, processes, rules that will allow a check of pre-established criterion to be performed to determine if music streaming or playback is going to be allowed and/or if such playback or streaming is allowable or authorized. In some exemplary embodiments, after a check is made as to configuration and authorization (Step 110), and a determination is made that such a check provides that music streaming is authorized (YES, Step 120), then the process associated with music streaming or music play back proceeds to step 130, where an icon, button or other feature (i.e., the radio bar) is displayed to the end user, indicating to the end user that he/she can proceed with the music streaming or playback.

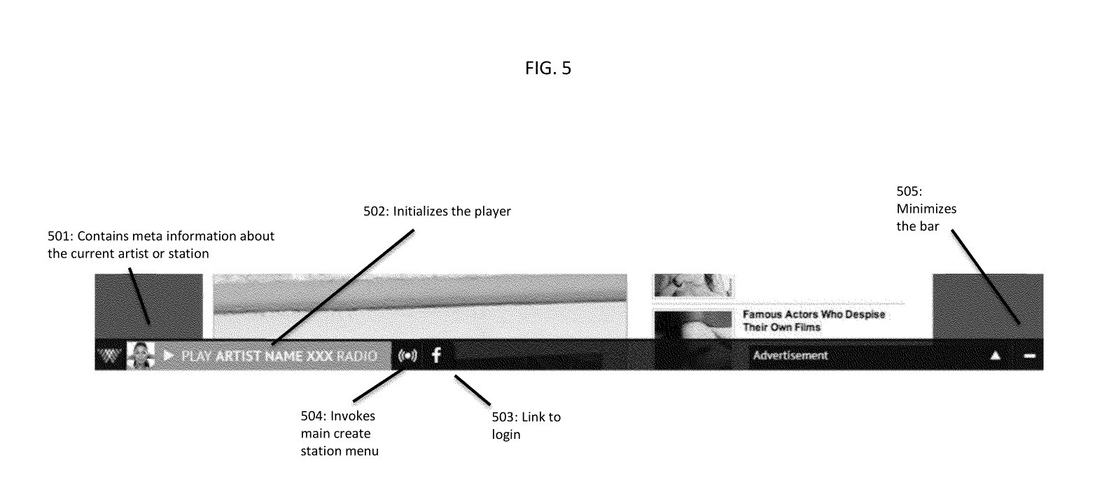

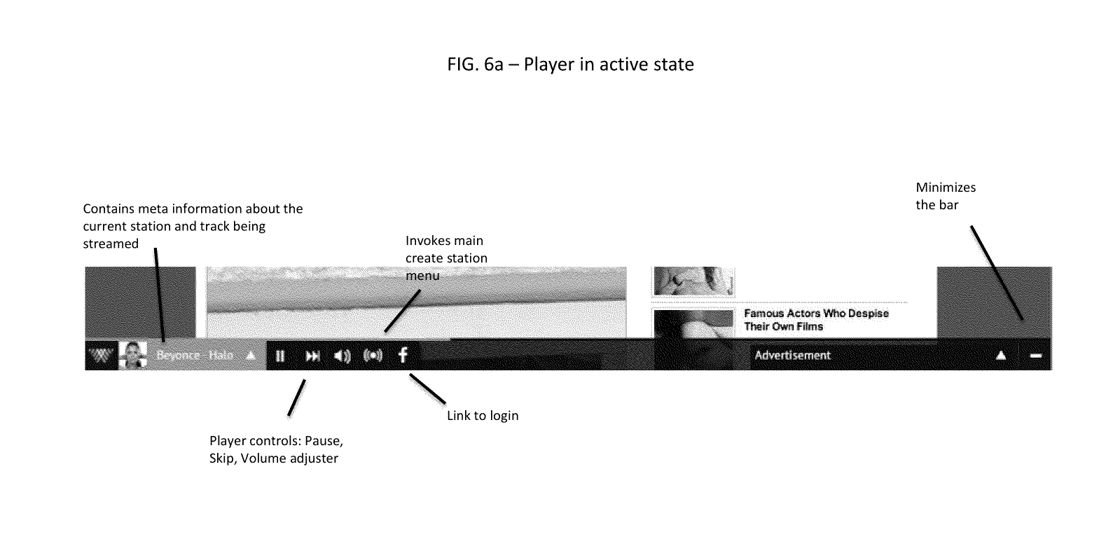

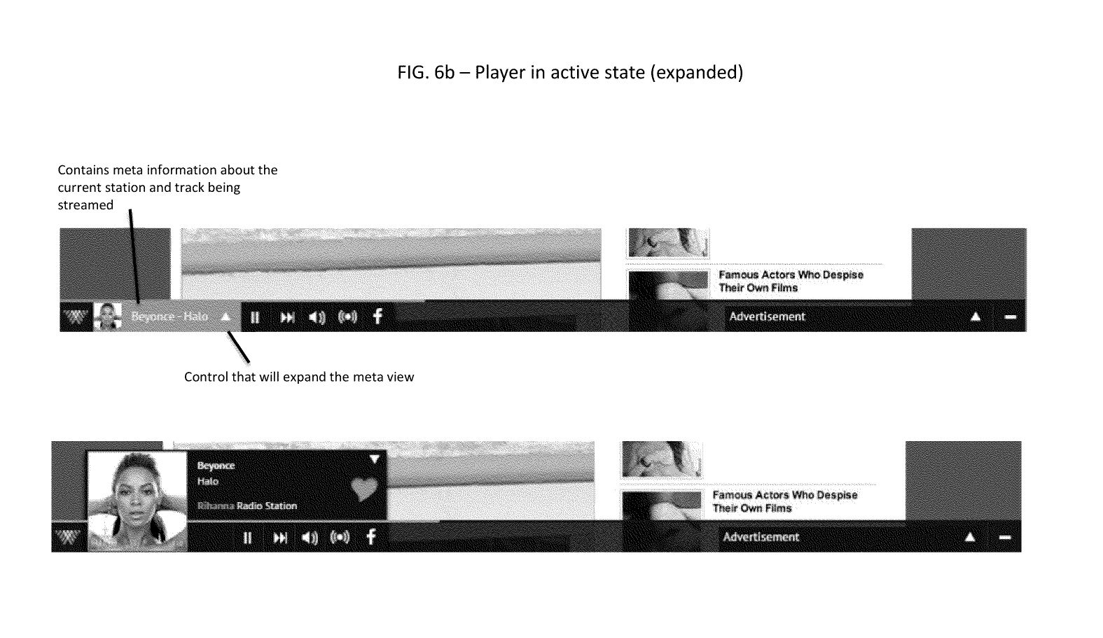

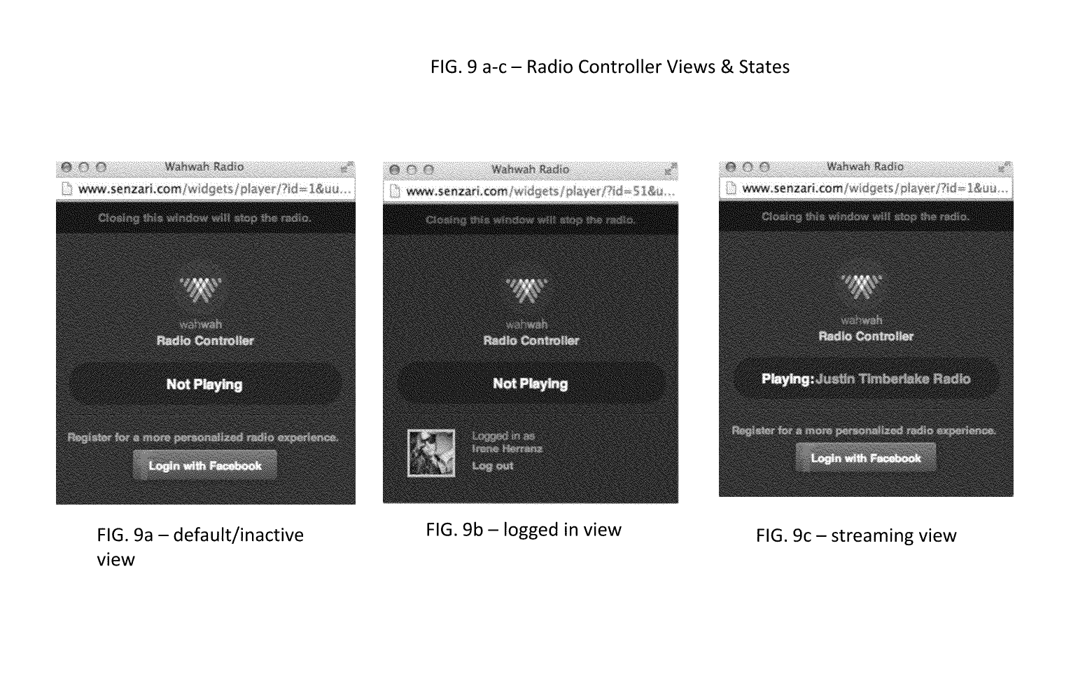

FIGS. 5, 6A-6B, 7, 8, and 9A-9C are screen shot illustrating components of an exemplary radio bar and radio controller in one embodiment of the present invention. This depicts the initial view and state of the radio bar on page load. The station and song Meta section of the radio bar 501 can display any or all of the following meta data received from the server streaming the media: album cover art; copy, station or song name; a title of the streamed media; a name of an artist associated with the streamed media; and/or the user name of the creator. In FIG. 5 there are provided various visual queues representing various calls to action for the end user to initiate the streaming sessions; especially any play icon or button 502. By activating such a button/icon/feature, the process proceeds with activating a controller (e.g., the Radio controller 200, FIG. 2B), Step 132. The controller process may be implemented via any desired user interface control, such as a pop-under window (i.e., a window that spawns behind a browser window that the user is accessing the web page of the publisher) or a pop-up window. The pop-under window (or other user interface control) may be spawned in response to manipulation of the radio bar by a user. In this manner, the radio bar 501 and the radio controller 200 operate to provide streaming media to the user.

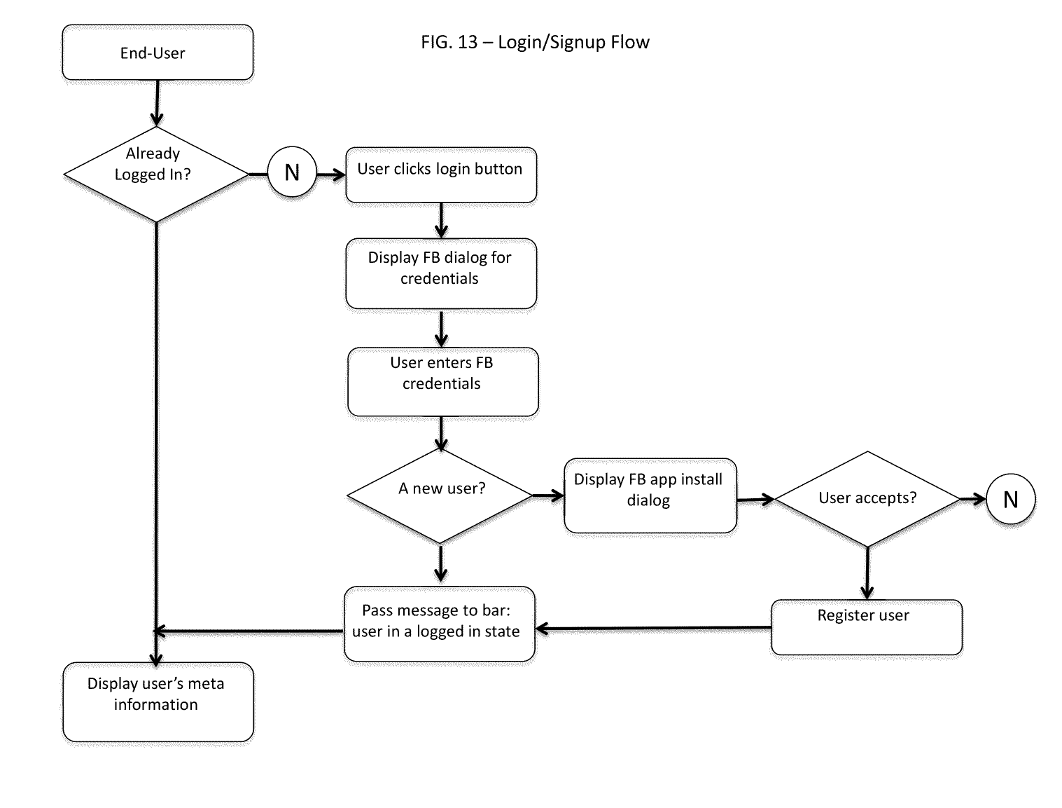

The controller 200 establishes communication with the server 300, allowing the controller to serve as the proxy between the client and back-end services. Communication(s) between the controller 200 and the back-end services are for retrieving the stream urls, media meta information, the user's data, status and tracking activities. The controller 200 also passes user and meta information to the radio bar 110 (FIG. 2B) for synchronization of data. The controller 200 forwards data, signal or information so that such information can be displayed to the end user, Step 134. Another call to action includes the option for the end user to login to the music streaming service by clicking on the login link 503. The controller 200 may also provide information (such as information regarding the user) to the server. FIG. 13 illustrates another exemplary process by which an end user may login and/or sign up to use or install a radio controller in order to receive streamed media.

Additional communications links may be established (Step 136) between any of the components in various embodiments. For example, the controller 200 may communicate with any other desired components.

In one exemplary embodiment, a pop-under window is created thereby allowing communications (e.g., establish a communications link) between the controller 200 and the digital device or digital processing device of the end user. Such a pop-under window establishes a communication link to the end user's digital device or digital processing device so as to allow the back-end services to be communicated to the end user's digital device or digital processing device thereby allowing the music to be streamed to such a device and thereafter play backed by such a device. More specifically, such a communication link allows the back-end services to be communicated directly to the end user's digital device or digital processing device. The streamed media is preferably not downloadable, thereby protecting against unauthorized duplication and redistribution of the media.

The pop-under window also can be arranged so as to maintain state so that when the end-user navigates to additional pages on the publisher's site, the radio bar will request the current state from the controller and reflect this information for syncing. In addition, the communication between the controller and the back-end services are for retrieving the stream urls, media meta information, user's collection, status and tracking activities. Also, the controller is configured so as to pass all user and meta information to the radio bar for synchronization of data.

This pop-under window advantageously provides a mechanism by which music can be directly streamed to the end user's computer or terminal for play back from a legal source of such music. This thereby avoids the need for the website to be specifically configured to provide such a music streaming service and obtaining and maintaining licenses for, ownership of, or using other legal methods so that the website owner/publisher can provide music to the public (e.g., end).

Thereafter, the process proceeds to Steps 140, 142, 150 and 152 where the end user can obtain information as to recommendations for listening as well as identifying other sources of music for listening. In one case, the end user can request a music recommendation (Step 140) and the controller can develop such a recommendation YES, Step 140, 142. For example, a process can be undertaken to develop one or more recommendations as to artists, different genre of music, music relating to the products being searched, and type of music being played locally.

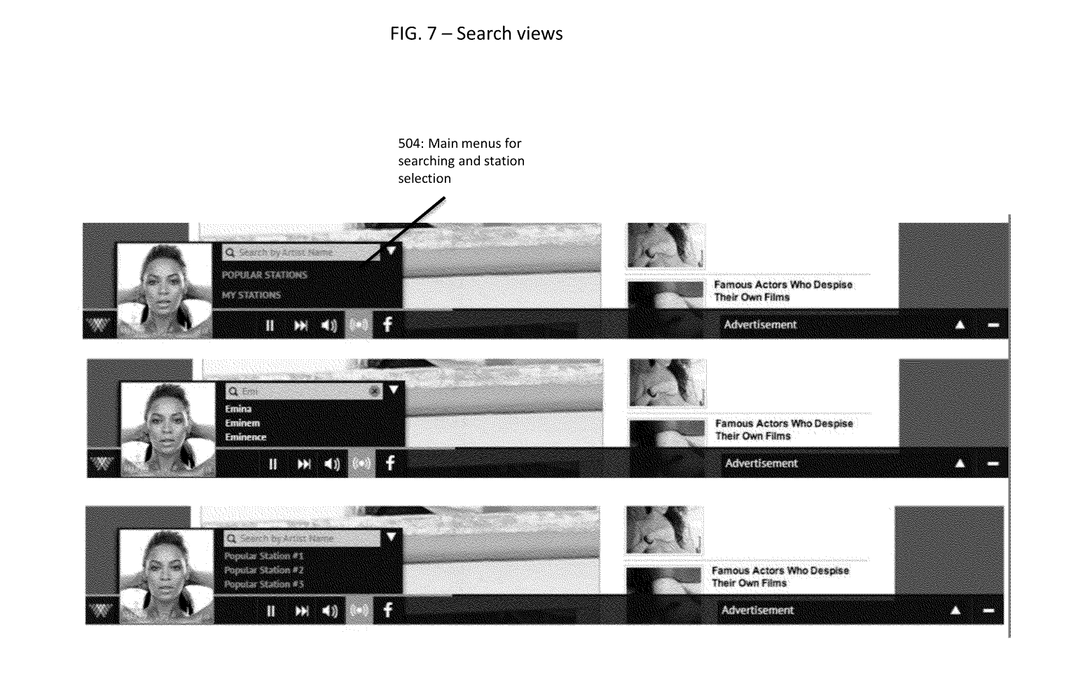

If a music recommendation is not being sought (NO, Step 140), then the process proceeds to identifying different musical sources to the end user, Step 150. In alternative embodiments, the process can be arranged so as to allow the end user to obtain a recommendation and identify other music sources, such as shown in the main menu 504 shown in FIG. 7. As indicated herein, the website owner/publisher can identify music which can be played by an end user while visiting its website, so the music being identified can be limited to this music or it can be combined with any other music as discussed herein.

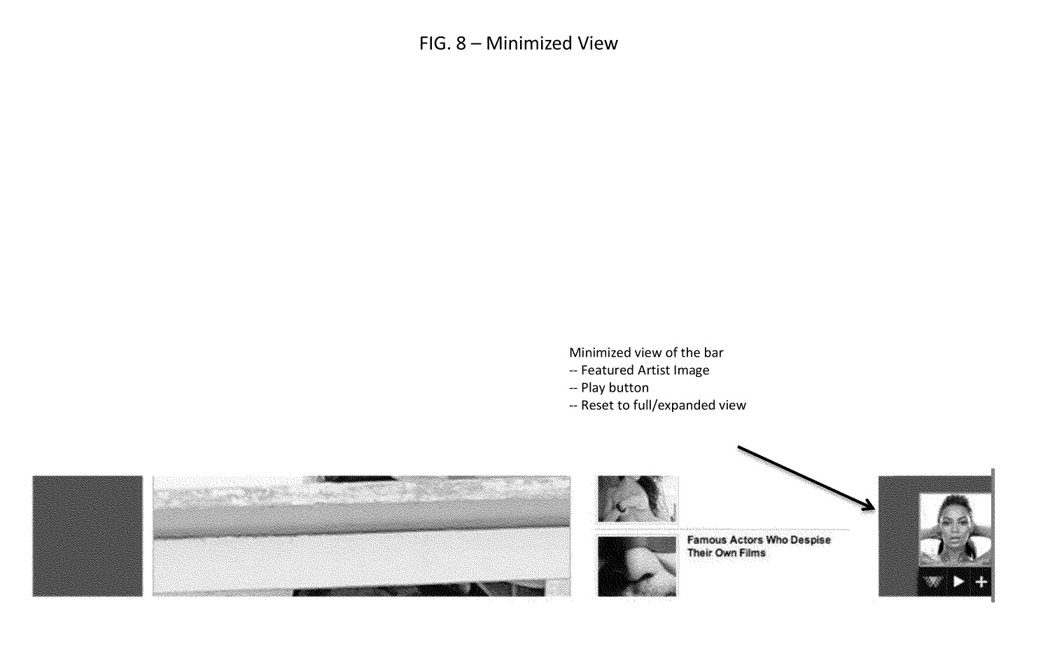

As shown in FIG. 5 for example, should the end user want to see what is available for station selections or create a station, they can click on the station main menu link 504 (FIG. 5). The main menu 504 will contain a search bar and menu links to stations that are popular, recommended or their own. In addition, as the end user navigates within the publisher's site, the end user has the option to minimize the bar for added viewing room 505. For example, the bar can be minimized to the bottom corner of the page with player controls, featured artist image and an expand button as shown in FIG. 8.

After one or more recommendations are provided (Step 142) and/or other music information is provided (Step 150), the end user considers the provided information and selects what music they want to listen to while they are connected to the website, Step 152.

Thereafter, the controller establishes and maintains the connection between the selected source of music and the end user's digital device (e.g., terminal or computer) while they are connected to the website, Step 154 until the end user decides to stop playing that music (Step 160). If the decision is not to stop playing music (NO, Step 160), then the process continues with maintaining the connection to the source of so music streaming or playback continues, Step 154.

If the decision is to stop playing the music being played (YES, Step 160), then the process proceeds to Step 170 to determine if it is desired to re-vitalize the radio bar so that other music can be played or alternatively, to in effect a stoppage of playing music. If it is determined that the radio bar should be revitalized (YES, Step 170), then the process proceeds to Step 172 wherein the radio bar is reset. In further embodiments, the pop-under window also is closed. Thereafter, the process continues with the steps described herein that would necessary to resume the streaming and playback of the music. Hereinafter, there is provided a discussion concerning an exemplary process for resetting the radio bar and closing the pop-under window.

If the end user decides not to reset the radio bar or close the pop-under window (NO, Step 170) then the process continues with determining if the end user otherwise ended browsing of the website such as by logging off from the website or breaking the connection with the website so as to thereby cause streaming to be ended, Step 180. In such a case, the methods of the present disclosure contemplate undertaking a process for an orderly shutdown of music streaming. Hereinafter, there is provided a discussion concerning an exemplary process for deactivating or stopping of the music streaming when the publisher's site browser window is closed.

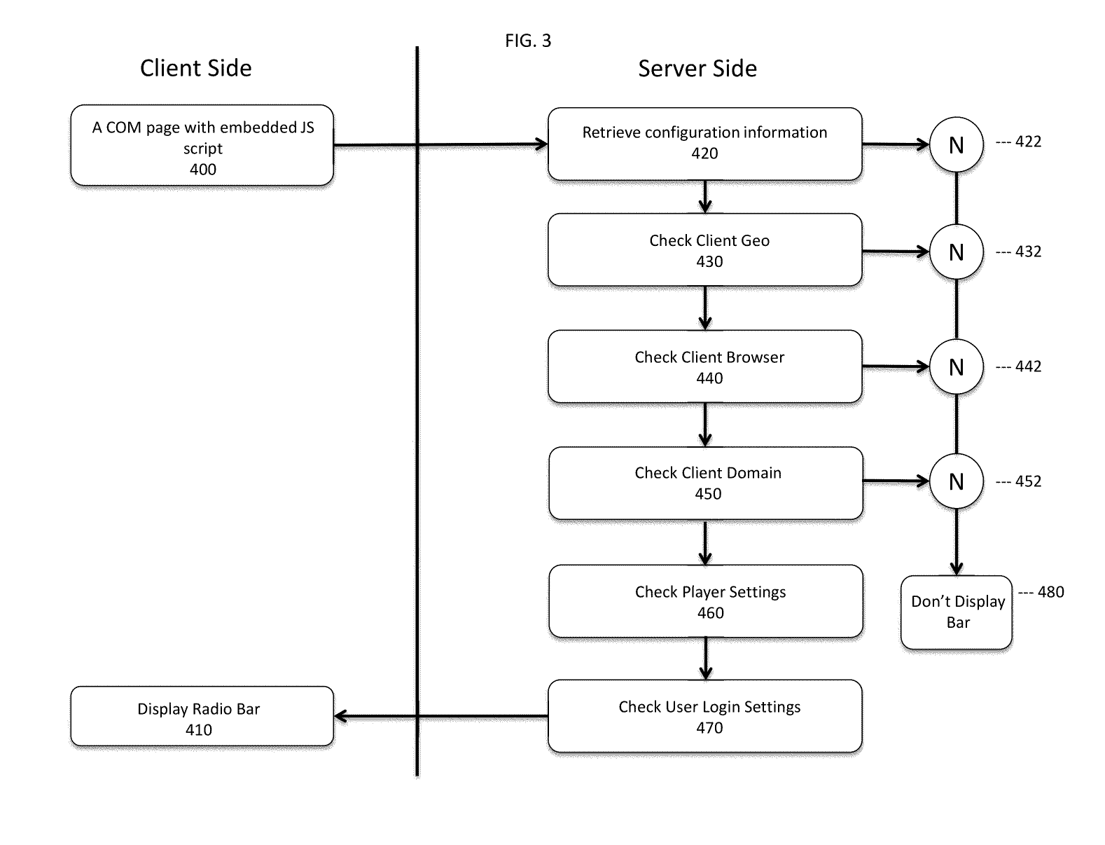

Referring now to FIG. 3 there is shown is a flow diagram illustrating an exemplary process that is directed to performing configuration checks according to one aspect of the present disclosure. As illustrated, such a figure has a client side and a server side.

A COM page 400 on the client side is accessible by a web browser that contains the embedded JS code. The JS code, during initialization, communicates with the server-side API's to retrieve the publisher's configuration settings (Step 420), that are used to instantiate the radio bar 110. It should be noted that the configuration settings are unique for each publisher. As described below, various information may be provided to the server by the radio controller for validation and verification. In some embodiments, the radio controller may control, based on the server's validation/verification response whether or not the media is streamed to the user. In other embodiments the server may simply not stream the media to the radio controller.

The JS code passes the publishers unique web widget identifier and an auto-generated session ID to the server. As described further herein, the Server-side checks for a match and if not available (NO, Step 412), then the radio bar will not render nor be displayed Step 480.

The end-users geographical location is checked to determine if they are in one of the authorized territories where the supplier of the music is licensed to stream the music, Step 430. If the end user is outside the authorized territories (NO, Step 432), then the radio bar 110 will not render (i.e., not displayed to end user), Step 480.

If the end-user is within the authorized territories (YES, Step 430), then the server performs a browser client check, Step 440. Typically, users must have browser version equal to or higher than the minimum requirements to ensure optimal user experience and in order for the browser to show. If the end user does not pass the browser client check (NO, Step 442), then the radio bar 110 will not render (i.e., not displayed to end user), Step 480.

If the end user passes the browser test (YES, Step 440), then the server checks the sites domain against what is stored in the configuration settings for that widget, Step 450. If the server fails to authenticate the domain against information on record (NO, Step 452), then the bar will not render (i.e., not displayed to the end user), Step 480. As indicated above, if any of the steps defined in 430, 430, 440 and 450 fail, then the Radio bar may not be displayed to the end user Steps 422, 432, 442, 452, 480. In other embodiments, the radio bar may be selectively displayed if only some of the authentication processes are successful.

If there are customizations or editorial features, requested by the publisher, then such configuration settings may be passed to the radio bar to reflect such, Step 460. Also, if the end user is already associated with the music streaming/music playback service in another fashion, and a token or other artifact (e.g., Facebook authentication token) is still active, then the radio bar will check for any associated login settings and the radio bar will render with the end user's profile photo and user stations, Step 470. In this way, the end user can access additional stations, artists or music types than that provided or allowed by the website. In this exemplary illustrative embodiment, after determining that all tests are passed and after determining if there are any further customizations or editorial features, the radio bar is rendered to the end-user, Step 410.

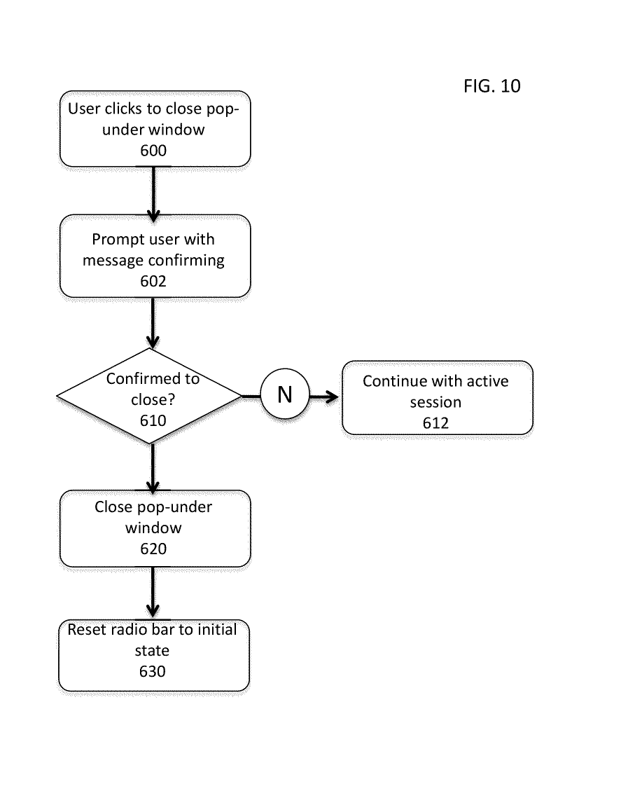

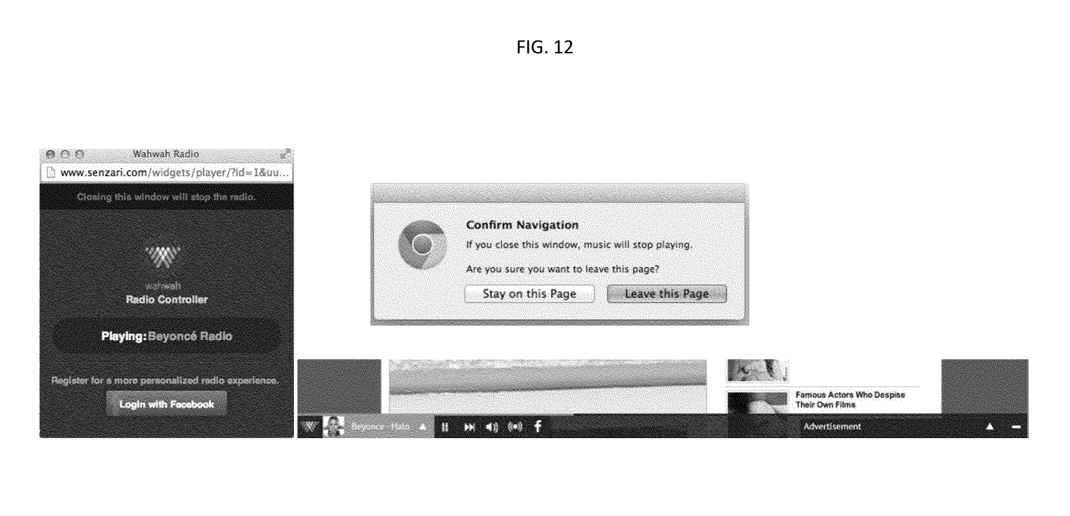

The end user may cancel the stream of media in various ways, such as providing input that indicates the user wishes to close the streaming session. Referring now to FIG. 10, there is shown a flow diagram illustrating an exemplary process for resetting the radio bar by closing the pop-under window, Step 600. If the radio controller 200 (FIG. 2) is loaded and the end-user/user decides to close it, a prompt is displayed to the end user for confirmation of the action, Step 602. In more particular embodiments, the browser's alert dialog (see FIG. 12) is displayed to the end user to confirm the action and to determine if the action is confirmed or not, Step 610. Thereafter, and as described below, the request is processed to either close the streaming session or keep it open.

In the event the end user decides to cancel leaving the streaming session (NO, Step 610), then the dialog would close and the process continues with the active session (i.e., no service interruption would occur), Step 612. For example, the end user could activate the “Stay on this page” icon/button as shown on FIG. 12 to cause the active playback session to continue.

If the end user confirms their intention to close the pop-under (YES, Step 610), then the radio controller would close the pop-under window, Step 620. Closing the pop-under window would close or terminate the communications link with the end user's terminal/computer, over which the music is/was being streamed for playback. For example, the end user could activate the “Leave this page” icon/button as shown on FIG. 12 to cause the active playback session to terminate.

Upon selecting “Leave this page” icon/button or another named button/icon having a similar effect, the radio controller pop-under window would be closed. Likewise, the pop-under window may be closed in response to the user navigating away from the publisher's web page or simply closing the browser.

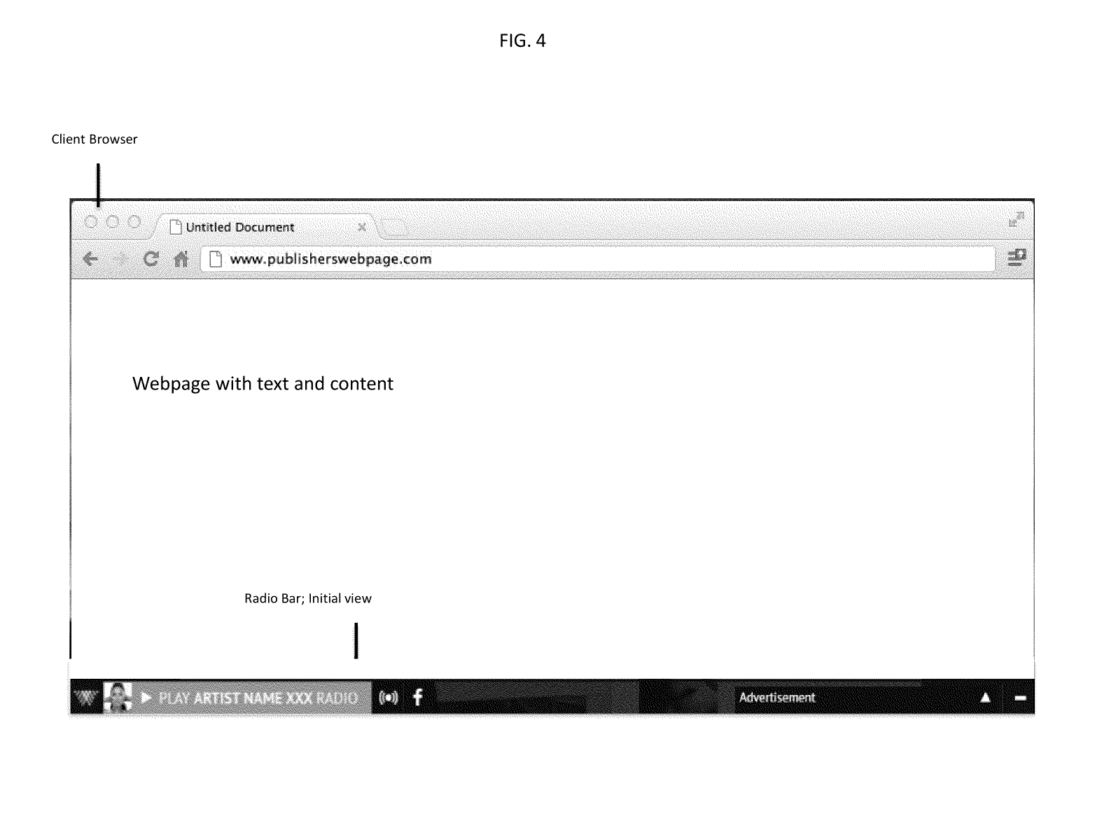

After such closure of the pop-under window by the radio controller, the radio bar would refresh itself back to the initial state (see FIG. 4) and the streaming session or the active session would be ended, Step 630.

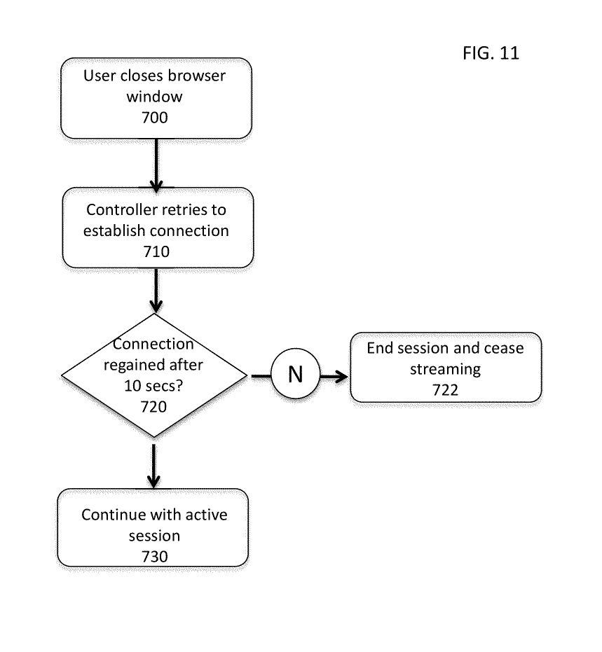

Referring now to FIG. 11, there is shown a flow diagram illustrating a process for deactivating music streaming by closing the publisher's site/browser window. In the case where the end user/user leaves the publishers website (e.g., the end user closes the browser window, Step 700); the radio controller remains open even though the connection between the end user's terminal/computer and the website is in effect broken.

Thereafter the radio controller 200 tries to establish connection with the radio bar 110 for synchronization, Step 710. As the radio bar 110 is no longer being rendered, the radio controller will continue to poll for an preset amount of time thereafter, for example 10 seconds to determine if the connection has bee regained, Step 720. If no reconnection has been established over the set period of time (NO, Step 720), then the radio controller 200 auto-closes and ends the streaming session. In the event the controller 200 and bar 110 do reestablish a connection (YES, Step 720); then the streaming service continues with no interruption (i.e., the active session is continued), Step 730.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

A machine readable medium can be used to store software and data that, when executed by a computer system, causes the computer system to perform various methods. The executable software and data may be stored in various types of memory, including ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

In various embodiments, hardwired circuitry may be used in combination with software instructions to implement the methods described herein. Thus, such methods are neither limited to any specific combination of hardware circuitry and software, nor to any particular source for the instructions executed by the data processing system.

Although some of the drawings illustrate a number of operations in a particular order, operations which are not order dependent may be reordered and other operations may be combined or broken out. While some reordering or other groupings may be specifically mentioned, others will be apparent to those of ordinary skill in the art and so do not present an exhaustive list of alternatives. Moreover, it should be recognized that the stages could be implemented in hardware, firmware, software or any combination thereof.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

Various functionality may be performed via a web browser and/or application interfacing utilizing a web browser. Such browser applications may comprise Internet browsing software installed within a computing unit or a system to perform various functions. These computing units or systems may take the form of a computer or set of computers, and any type of computing device or systems may be used, including laptops, notebooks, tablets, hand held computers, personal digital assistants, set-top boxes, workstations, computer-servers, main frame computers, mini-computers, PC servers, network sets of computers, personal computers and tablet computers, such as iPads, iMACs, and MacBooks, kiosks, terminals, point of sale (POS) devices and/or terminals, televisions, or any other device capable of receiving data over a network. Various embodiments may utilize Microsoft Internet Explorer, Mozilla Firefox, Google Chrome, Apple Safari, Opera, or any other of the myriad software packages available for browsing the Internet.

Various embodiments may operate in conjunction with any suitable operating system (e.g., Windows NT, 95/98/2000/CE/Mobile/, Windows 7/8, OS2, UNIX, Linux, Solaris, MacOS, PalmOS, etc.) as well as various conventional support software and drivers typically associated with computers. Various embodiments may include any suitable personal computer, network computer, workstation, personal digital assistant, cellular phone, smart phone, minicomputer, mainframe or the like. Embodiments may implement security protocols, such as Secure Sockets Layer (SSL), Transport Layer Security (TLS), and Secure Shell (SSH). Embodiments may implement any desired application layer protocol, including http, https, ftp, and sftp. The various system components may be independently, separately or collectively suitably coupled to a network via data links which includes, for example, a connection to an Internet Service Provider (ISP) over the local loop as is typically used in connection with standard modem communication, cable modem, satellite networks, ISDN, Digital Subscriber Line (DSL), or various wireless communication methods. It is noted that embodiments of the present disclosure may operate in conjunction with any suitable type of network, such as an interactive television (ITV) network.

Embodiments of the present disclosure may be partially or fully implemented using cloud computing. “Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

Various embodiments may be used in conjunction with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically.

Any databases, systems, devices, servers or other components of the system may be located at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, and symmetric and asymmetric cryptosystems.

Embodiments may connect to the Internet or an intranet using standard dial-up, cable, DSL or any other Internet protocol known in the art. Transactions may pass through a firewall in order to prevent unauthorized access from users of other networks.

The computers discussed herein may provide a suitable website or other Internet-based graphical user interface which is accessible by users. For example, the Microsoft Internet Information Server (IIS), Microsoft Transaction Server (MTS), and Microsoft SQL Server, may be used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In another example, an Apache web server can be used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL and an IP address. The web server retrieves the appropriate web pages and sends the data or applications for the web pages to the IP address. Web services are applications that are capable of interacting with other applications over a communications means, such as the Internet.

Various embodiments may employ any desired number of methods for displaying data within a browser-based document. For example, data may be represented as standard text or within a fixed list, scrollable list, drop-down list, editable text field, fixed text field, pop-up window, and the like. Likewise, embodiments may utilize any desired number of methods for modifying data in a web page such as, for example, free text entry using a keyboard, selection of menu items, check boxes, option boxes, and the like.

The exemplary systems and methods illustrated herein may be described in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like.

The systems and methods of the present disclosure may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” should be construed to exclude only those types of transitory computer-readable media which were found in In Re Nuijten to fall outside the scope of patentable subject matter under 35 U.S.C. §101.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

What is claimed is:

1. A computer-implemented method comprising:
accessing, by a user computer system using, a web page hosted by a publisher computer system;
receiving, by the user computer system, input from a user of the user computer system requesting streaming media via the web page;
establishing, by the user computer system, a connection with a server providing the streaming media; and
providing, by the user computer system, the streaming media from the server to the user via the web page.

2. The method of claim 1, wherein the streaming media is provided via a user interface control embedded in the web page hosted by the publisher computer system.

3. The method of claim 2, wherein the user interface control includes a pop-under window.

4. The method of claim 3, wherein the user interface control further includes a radio bar, and wherein the pop-under window is created in response to manipulation of the radio bar by the user.

5. The method of claim 2, further comprising receiving meta data regarding the streamed media from the server and providing the meta data to the user interface control.

6. The method of claim 5, wherein the meta data includes one or more of: album cover art, a title of the streamed media, a name of an online station streaming the media, and a name of an artist associated with the streamed media.

7. The method of claim 2, wherein the user interface control is downloaded to the user computer system from the server.

8. The method of claim 7, wherein the user interface control is downloaded to the user computer system asynchronously.

9. The method of claim 1, wherein the streaming media comprises one or more of: audio and video.

10. The method of claim 1, wherein the streaming media is not downloadable.

11. The method of claim 1, further comprising providing, by the user computer system, information regarding the user to the server.

12. The method of claim 1, further comprising:
determining, by the client computer system, a web widget identifier;
automatically generating, by the client computer system, a streaming media session identifier;
providing the web widget identifier and the media session identifier to the sever;
receiving, from the server, an indicator from the server as to whether the web widget identifier and the media session identifier are authenticated; and
providing the streaming media via the web page only in response to a successful authentication.

13. The method of claim 1, further comprising:
identifying, by the user computer system, a geographical location of the user;
providing the geographical location of the user to the server;
receiving an indication from the server as to whether the user is within a territory for which there is a license to provide the streaming media; and
providing the streaming media via the web page only in response to an indication that the user is within a licensed territory.

14. The method of claim 1, further comprising:
identifying, by the user computer system, a version of a browser used by a user viewing the web page;
providing the browser version to the server;
receiving an indication from the server as to whether the browser meets a minimum requirement based on the browser version; and
providing the streaming media via the web page only in response to an indication that the browser meets the minimum requirement.

15. The method of claim 1, further comprising:
identifying, by the user computer system, a domain of the web page;
providing the web page domain to the server;
receiving and indication as to whether the web page domain is authenticated; and
providing the streaming media via the web page only in response to a successful authentication.

16. The method of claim 1, further comprising discontinuing the providing of the streaming via the web page in response to input from the user cancelling the streaming.

17. The method of claim 16, wherein the input from the user cancelling the streaming includes the user navigating away from the web page in a browser.

18. The method of claim 16, wherein the input from the user cancelling the streaming includes closing one or more of: a browser in which the web page is displayed, and a user interface control through which the streaming media is provided.

19. A tangible, non-transitory computer-readable medium storing instructions that, when executed, cause a user computer system to:
access a web page hosted by a publisher computer system;
receive input from a user of the user computer system requesting streaming media via the web page;
establish a connection with a server providing the streaming media; and
provide the streaming media from the server to the user via the web page.

20. A system comprising:
at least one processor; and
memory in communication with the at least one processor and storing instructions that, when executed by the processor, cause the system to:
access a web page hosted by a publisher computer system;
receive input from a user of the system requesting streaming media via the web page;
establish a connection with a server providing the streaming media; and
provide the streaming media from the server to the user via the web page.
